(19) United States
(12) Patent Application Publication
(10) Pub. No.: US 2023/0126198 A1
(43) Pub. Date: Apr. 27, 2023

(54) PROCESS FOR INERTING ELECTROCHEMICAL ACCUMULATORS, ESPECIALLY METAL-ION ACCUMULATORS, BY INITIAL IMMERSION IN A SOLUTION OF CALCIUM CHLORIDE AT LOW TEMPERATURE, FOLLOWED BY ELECTRICAL SHORT-CIRCUITING IN PREPARATION FOR THEIR SHREDDING

(71) Applicant: COMMISSARIAT A L'ENERGIE ATOMIQUE ET AUX ENERGIES ALTERNATIVES, Paris (FR)

(72) Inventors: Rémi VINCENT, Grenoble Cedex 09 (FR); Kamel BACHIR ELEZAAR, Grenoble Cedex 09 (FR); Clémence LY, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/049,702

(22) Filed: Oct. 26, 2022

(30) Foreign Application Priority Data
Oct. 26, 2021 (FR) 21 11377

(51) Int. Cl. H01M 10/54; H01M 10/0525; H01M 4/583; H01M 4/40; H01M 4/485; H01M 4/505; H01M 4/525; H01M 10/613; H01M 10/6567

(52) U.S. Cl. CPC H01M 10/54; H01M 4/405; H01M 4/485; H01M 4/505; H01M 4/525; H01M 4/583; H01M 10/0525; H01M 10/613; H01M 10/6567; H01M 2004/027

(57) ABSTRACT

A process for inerting electrochemical accumulators, especially metal-ion accumulators, by initial immersion in a solution of calcium chloride at low temperature, followed by electrical short-circuiting in preparation for their shredding.

The invention consists essentially of the generation of a short circuit in electrochemical accumulators immersed in an aqueous CaCl² solution, the low temperature of which in the liquid state, typically -50° C., ensures thermal absorption of the heat evolved by the accumulators and therefore reliably prevents them from undergoing thermal runaway, said short-circuiting taking place prior to, and separately from, the shredding of the accumulators.

### TECHNICAL FIELD

The present invention relates to the field of electrochemical accumulators and, more particularly, to metal-ion accumulators or accumulators of other chemistries (lead, etc.).

The invention aims firstly to ensure the electrical discharge of accumulators through short-circuiting before they are recycled, and without generating thermal runaway in said accumulators.

Although described with reference to a lithium-ion accumulator, the invention is applicable to any metal-ion electrochemical accumulator, i.e. also to sodium-ion, magnesium-ion and aluminium-ion accumulators or ones of other chemistries (lead, etc.).

### PRIOR ART

With the huge growth in mass-market electric vehicles using lithium-ion batteries, the production of the latter has increased considerably.

Among end-of-life strategies for lithium-ion batteries, recycling used batteries is one solution for achieving sustainability and minimal environmental pollution.

The inerting of lithium-ion batteries is an essential step prior to the recycling process itself, so as to ensure the safety of people and of the environment during their recycling. This is because one of the steps in recycling is to carry out shredding of the accumulators.

During this shredding, if an accumulator has not been completely discharged, there is a risk of short-circuiting, which causes the accumulator to heat up and can lead to thermal runaway thereof. If this occurs, there is not only a physical risk on account of the potential for explosions and fires, but also a chemical risk on account of the toxic fumes that can be produced during runaway. Similarly, where transport needs to be provided for end-of-life accumulators destined for recycling, transporting accumulators that have previously been inerted contributes to safety.

A process that permits the fast and safe discharge of a large number of accumulators so that they can be subsequently recycled consists of immersing the accumulators, after first separating them from one another, in a tank containing an NaCl solution of a given concentration.

FIG. 1 shows a schematic representation of a system executing such a process: the accumulators A1, A2, ... Ax in which the electrochemistry is still active are submerged in a tank 1 containing an NaCl solution introduced through a supply conduit 2. The NaCl solution may be drawn off through an outlet conduit 3.

Provided the voltage V between the output terminals of an accumulator A1, A2, ... Ax is greater than 1.23 V, salt water will undergo hydrolysis according to the following reaction equations:
at the negative terminal: H₂O = 1/2O₂ + 2H⁺ + 2e⁻
at the positive terminal: 2H⁺ + 2e⁻ = H₂.

Consequently, each accumulator that is electrochemically active will undergo gradual electrical discharge. The rate of hydrogen release resulting from the hydrolysis can be substantial. The greater the number of accumulators, the greater the amount of dihydrogen generated by the hydrolysis.

By way of example, for submersion of a number equal to 8000 type 18650 accumulators in a concentrated 5% by weight NaCl solution, this has been measured at 103.7 ⅟s. Release of this amount of dihydrogen increases the explosive atmospheres (ATEX) risks. The ventilation equipment enclosing the discharge solution (NaCl) must be able to cope with the hydrogen release while remaining within acceptable limits. This impacts on the dimensions thereof and also on the number of accumulators that can be discharged at the same time, which is a function of their residual electrochemical activity.

The literature contains publications concerned with techniques for inerting accumulators by cooling.

Thus, patent US 7 833 646 B2 discloses a solution in which lithium batteries are shredded under a continuously cooled CO₂ gas flow. The temperature of the CO₂ gas is not mentioned. This solution has a number of drawbacks: firstly, it necessitates inerting under an atmosphere that entails substantial process systems. Also, cooling by means of a gas flow is a priori less effective than cooling by submersion in a liquid.

Patent US 5888463A proposes immersing lithium batteries in liquid nitrogen, which is at a temperature of the order of -196° C., then shredding them. This technique allows batteries to be shredded while ensuring that they do not undergo thermal runaway. On the other hand, the use of liquid nitrogen is costly and means going down to extremely low temperatures (-196° C.). The apparatus, in particular the shredding apparatus, therefore needs to be specifically designed to withstand such temperatures, which adds additional costs to the process.

There is therefore a need to provide a solution for inerting electrochemical accumulators, especially metal-ion accumulators, that is reliable, i.e. that permits shredding of accumulators without risk of fire or explosion and that can be realized at lower cost than prior art solutions.

The aim of the invention is to at least partially meet this need.

### DISCLOSURE OF THE INVENTION

To this end, the invention relates, in one of its aspects, to a process for inerting electrochemical accumulators (A), especially metal-ion accumulators, comprising the following steps:
0/ selecting a type of salt or mixture of salts, selecting the concentration(s) by weight thereof in an aqueous solution and selecting the cooling temperature for the aqueous solution that allows the accumulator(s) to stay at a temperature below or equal to the temperature termed the “thermal runaway temperature” T2, the selection additionally ensuring that the aqueous solution remains in a liquid state throughout cooling;
i/ supplying an aqueous solution of the salt or mixture of salts selected in step 0/;
ii/ cooling the aqueous solution of the salt or mixture of salts to the temperature determined in step 0/;
iii/ submerging the accumulator(s) in the cooled aqueous solution of the salt or mixture of salts;
iv/ short-circuiting the accumulator(s) in order to cause the electrical discharge thereof.

According to an advantageous embodiment, step i/ consists of supplying an aqueous solution of calcium chloride (CaCl₂). According to this embodiment, the concentration is advantageously between 0% and 30% by weight of CaCl₂.

Preferably, the temperature determined in step 0/ is above or equal to -50° C.

More preferably, step iv/ is carried out by piercing or crushing the casing of the accumulator(s).

More preferably, step iv/ is carried out for a time (t) of between 0.5 and 7 h, preferably less than 4 h.

The invention also provides a process for inerting a plurality of electrochemical accumulators such as those described above, the plurality of accumulators being assembled inside a module or inside a battery pack during steps iii/ and iv/ and where appropriate disassembled at the end of step iv/.

The invention further provides an accumulator that has been electrically discharged according to the process described above.

Each accumulator may be a Li-ion accumulator wherein:
the material of the negative electrode(s) is selected from the group comprising graphite, lithium and the titanate oxide Li₄TiO₅O₁₂;
the material of the positive electrode(s) is selected from the group comprising LiFePO₄, LiCoO₂ and LiNi_{0.33}Mn_{0.33}Co_{0.33}O₂.

The invention also relates to a process for recycling electrochemical accumulators, comprising a step of shredding of accumulators originating from the process described above.

The step of shredding is advantageously carried out subsequently to step iv/ and where appropriate in a different process system to the one executing steps i/ to iv/.

Thus, the invention consists essentially of the generation of a short circuit in electrochemical accumulators immersed in an aqueous CaCl₂ solution, the low temperature of which in the liquid state, typically -50° C., ensures thermal absorption of the heat evolved by the accumulators and therefore reliably prevents them from undergoing thermal runaway, said short-circuiting taking place prior to, and separately from, the shredding of the accumulators.

Regarding the phenomenon of thermal runaway, reference should be made to publication [1] and to the protocol described therein. The temperature termed the “thermal runaway temperature” is designated T2 in this publication.

The temperature T2, typically 150° C., in FIG. 2 of the publication is the temperature at or above which the accumulator heats up at a typical heating rate of 10° C./min under adiabatic conditions, leading to melting of the separator in the electrochemical array of the accumulator, to short-circuiting and thus to a voltage collapse.

“Thermal runaway” can thus be understood here and in the context of the invention as meaning a ratio between the value of the derivative of the heating temperature and that of time of at least 0.02° C. per min.

The invention has many advantages, including the following:
ensuring that accumulators to be recycled can be shredded, and also transported prior to shredding, in complete safety;
the execution of a lower-cost, low-temperature process, typically at -50° C., in place of a cryogenic shredding process in liquid nitrogen (-196° C.) as per the prior art, which is very costly in terms of investment and operating costs;
the possibility of simultaneously inerting more than one accumulator in the same module or battery pack, which simplifies and makes safe the volt-free dismounting of the module or battery pack before the shredding step and thus means there is no need for the module or battery pack to be introduced into a shredder in its entirety; this can be instead done in groups of separated accumulators or even one accumulator at a time;
the possibility of complete recycling of accumulators on two separate industrial systems, one dedicated to carrying out short-circuiting during submersion of the accumulators in the aqueous solution cooled to low temperature and the other dedicated solely to the shredding of the short-circuited accumulators, the physical integrity of which has not been compromised beforehand (crushing).

Other advantages and features of the invention will become apparent from reading the detailed description of working examples of the invention, given by way of non-limiting illustration with reference to the figures that follow.

### BRIEF DESCRIPTION OF THE DRAWINGS

FIG. 1 is a schematic view of a system according to the prior art for inerting lithium-ion accumulators by submersion in an NaCl solution.

FIG. 2A is a schematic view of a system according to the invention for inerting a lithium-ion accumulator through executing a step of submersion in an aqueous solution of calcium chloride (CaCl₂) cooled in a cooling chamber.

FIG. 2B is a schematic view showing a subsequent step in which the accumulator submerged in the cooled solution is pierced by a spike.

FIG. 2C is a schematic view of the resulting step of piercing the accumulator, in which the solution and the accumulator are short-circuiting and the water of the solution undergoes electrolysis.

FIG. 3 is a schematic view illustrating a variant of short-circuiting by crushing the accumulator.

FIG. 4 illustrates, in the form of graphical plots, the time course of the temperatures of an aqueous CaCl₂ solution and of a Li-ion accumulator that has been submerged therein, during tests according to the process of the invention.

FIG. 5 illustrates, in the form of graphical plots, the course of the voltage of the submerged accumulator during tests according to the process of the invention.

### DETAILED DESCRIPTION

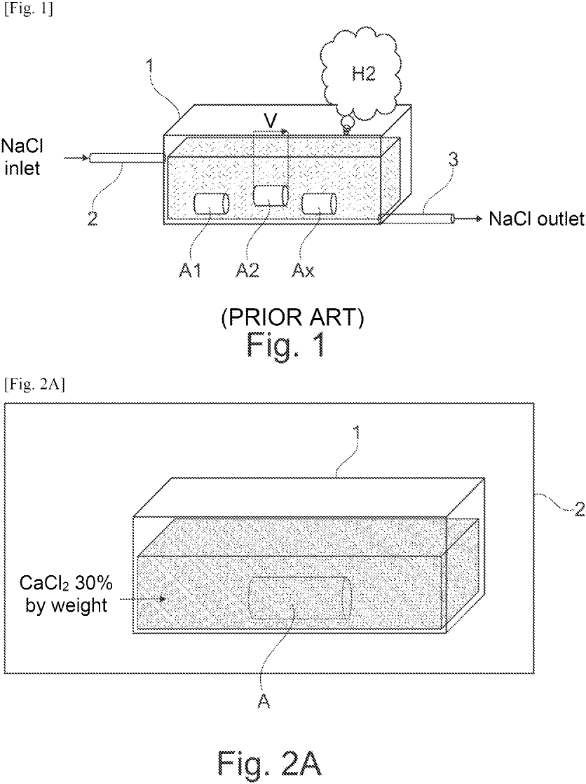

FIG. 1 relates to a system executing direct inerting of a plurality of Li-ion accumulators according to the prior art. This FIG. 1 has already been commented on in the preamble and is therefore not commented on further below.

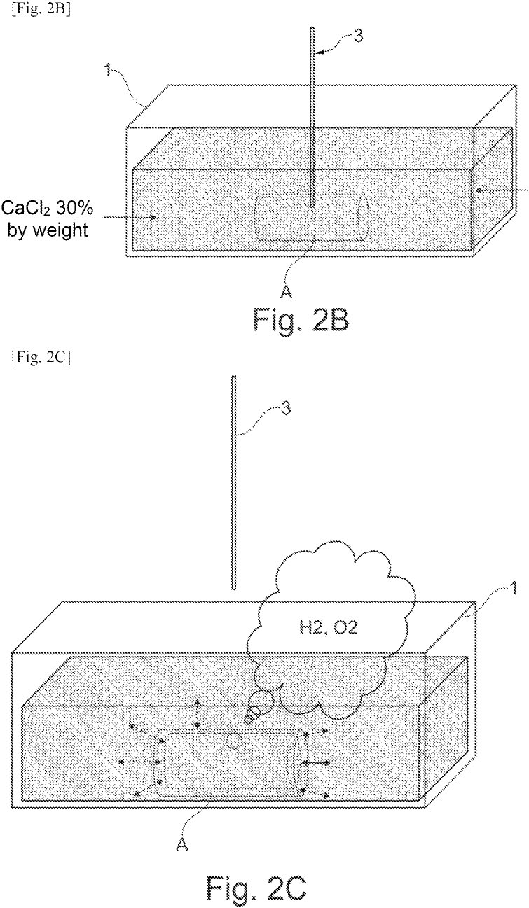

For the sake of clarity, the same references denoting the same elements according to the prior art and according to the invention are used for all of FIGS. 1 to 2B.

A process for inerting at least one Li-ion accumulator according to the invention will now be described.

Step 0/: Selecting a type of salt or mixture of salts, selecting the concentration(s) by weight thereof in an aqueous solution and selecting the temperature for the aqueous solution that ensures:
cooling of the heat output generated by a/the short-circuiting accumulator(s) sufficient to prevent thermal runaway in the accumulator(s), i.e. a temperature that makes it possible, through the increase in the internal resistance of the accumulator(s), to limit the current and consequently the heat evolved and thus to remain at a temperature below temperature T2 at which thermal runaway commences;
a liquid state in the aqueous solution throughout cooling, in particular a temperature above or equal to the temperature at which the solution passes from the solid state into the liquid state.

The cooling temperature is determined by the intrinsic characteristics of the accumulator(s) A, namely the internal resistance of the electrochemical cell(s) and of the electrolyte in the cell(s) making up the accumulator(s). This is because the heat output generated by short-circuiting depends on the internal resistance of the electrochemical cell(s) making up the accumulator(s) according to the equation: P = V²/Rᵢₙₜ, where V is the voltage of the cell(s) and Rᵢₙₜ the internal resistance of the cell(s). The internal resistance on the other hand depends on the temperature of the cell, which is why it is necessary to cool it strongly. Thus, knowing the internal resistance of the cell as a function of temperature, which can be determined experimentally, it is possible to deduce the heat output generated by the discharge of the battery at a given temperature, and therefore to ensure that the cell will be sufficiently cooled by its surroundings that it does not generate too much power, which could ultimately risk leading to thermal runaway.

The energy generated by the discharge of an accumulator, which is governed by the equation: E_{discharge} = V²/R_int^{∗}t_{discharge} where t_{discharge} is the discharge time, must be equal to the amount of heat exchanged as defined by the equation: Q = m_solution^{∗}[Cp]_solution^{∗}(T_cell-T_solution) in which V is the voltage of the cell, Rᵢₙₜ the internal resistance of the cell, m the weight of the solution of the salt(s) and Cp the specific heat capacity of the solution of the salt(s).

Other influences may also arise from the cooling system of the solution itself and the quality of heat exchange between the accumulator and the liquid medium. They can be improved by various means such as mechanical stirrers, liquid flows, etc. Taking into account these environmental factors, and allowing an appropriate margin, allows those skilled in the art to determine a maximum temperature of the selected aqueous solution at which thermal runaway of the accumulator can be prevented through the twin effect of limiting the heat produced as a consequence of increased internal resistance and dissipating through cooling the heat evolved. For reasons of safety, it is possible to opt for the effect of passive cooling only, without employing additional means of cooling, i.e. facilitating heat exchange or active cooling of the solution. A temperature below this maximum temperature will be chosen for the solution, while also ensuring that it remains in a liquid state, and not a solid state, especially throughout cooling.

If the given solution does not have a cooling temperature at which a liquid state, and not a solid state, is possible, other concentrations by weight must be considered, as must other salts or mixtures of salts.

Different salts in aqueous mixtures may be used provided the mixture has a eutectic at the desired temperature. For example, with 23.3% by weight of the salt NaCl it is possible to achieve -21° C. This is also possible with other salts: KCl, MgCl₂ or a mixture of salts.

An aqueous CaCl₂ solution having a CaCl₂ concentration of between 0% and 30% by weight makes it possible to achieve temperatures of between 0° C. and -50° C. in the liquid state.

Typically, for the aqueous solution of calcium chloride CaCl₂ at a concentration of 30% by weight, the lowest cooling temperature in the liquid phase is of the order of -50° C. With this concentration by weight, the solution is indeed liquid down to -50° C., a temperature that makes it possible to have a passive heat exchange coefficient with the accumulator(s) sufficient for absorption of the heat evolved during their electrical discharge while at the same time preventing them from undergoing thermal runaway. This is what has been chosen here.

Step i/: An aqueous solution is supplied of the salt or mixture of salts as defined previously, in this case of calcium chloride at a concentration of 30% by weight.

Step ii/: At this concentration, the solution is cooled to the temperature defined above.

Step iii/: In a tank 1 filled with the aqueous solution of calcium chloride CaCl₂ at a concentration of 30% by weight is submerged at least one Li-ion accumulator A, which is placed in a chamber 2 cooled to and maintained at -50° C. (FIG. 2A).

Step iv/: The tank 1 containing the accumulator A and the aqueous solution cooled to -50° C. is then taken out of the chamber 2 and left in the ambient air under an extractor hood (not depicted).

The casing of the accumulator A is then pierced by a spike 3 in order to generate a short circuit (FIG. 2B). It should be noted here that it is possible to use instead of a spike any other means of piercing that is suitable for piercing the casing of the accumulator.

The spike 3 is then retracted (FIG. 2C), thereby allowing the aqueous CaCl₂ solution to penetrate inside the accumulator. At a temperature of -50° C., the internal resistance of the accumulator A is such that the current generated by short-circuiting is very weak.

As the bath containing the aqueous solution with the accumulator A heats up through short-circuiting, so the accumulator A also discharges through short-circuiting.

The accumulator A additionally discharges through electrolysis of the water in the solution at its output terminals, since the aqueous CaCl₂ solution is conductive and since the voltage between the terminals is greater than the voltage of 1.23 V according to the reactions below.
at the negative terminal [Eq. 1]: H₂O = ½O₂ + 2H⁺ + 2e⁻
at the positive terminal [Eq. 2]: 2H⁺ + 2e⁻ = H2

The hydrogen and oxygen released during these reactions are drawn off by the hood.

The heating associated with short-circuiting is thermally absorbed by the cooled solution until the electrical discharge of the accumulator A is complete.

The accumulator A can thus be shredded for subsequent recycling without any risk of fire or explosion.

For the generation of the short circuit, instead of piercing the accumulator A with a spike, the accumulator A can be crushed. Just as in the case of short-circuiting through piercing with the spike, controlling the temperature of the aqueous calcium chloride solution ensures safety during crushing of the accumulator.

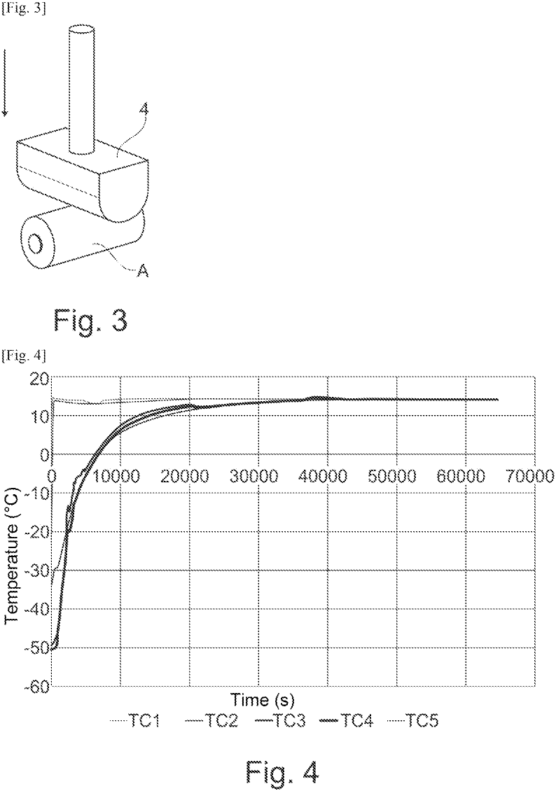

One crushing solution for an accumulator of cylindrical geometry A is shown in FIG. 3: a bar that is semicircular in cross section 4 is moved so as to crush the casing of the accumulator A. The advantage of a crushing solution is that this can prevent the liquid electrolyte contained in the accumulator A from draining out of its casing, therefore making it possible both to prevent contamination of the bath and to maintain the physical integrity of the accumulator. Maintaining the physical integrity of the accumulators A in turn facilitates their transport and storage, prior to shredding for recycling. This makes it possible for the shredding step to be performed at a different location than the submersion with short-circuiting, in complete safety.

The inventors have carried out a test to verify the feasibility of the inerting process according to the invention.

This was done using a type 18650 Li-ion accumulator charged to 3 Ah.

Its positive terminal was electrically insulated with a resin in order to simulate an accumulator in which the current interruption device (CID) is open. It should be remembered here that an internal CID device in the accumulator interrupts the electric current if the gas pressure inside the accumulator exceeds specified limits.

Said type 18650 accumulator was immersed in a bath containing an aqueous CaCl₂ solution at a concentration of 30% by weight and cooled to -50° C.

The type 18650 accumulator submerged in this aqueous solution was then pierced by a tungsten spike, which was retracted after 1 min to allow the solution to penetrate into the accumulator.

Thermocouples were placed on the terminals of the accumulator and in the CaCl₂ solution in order to monitor the heating of the accumulator.

The time course of the test temperatures are shown in FIG. 4, in which TC1, TC2, TC3, TC4 and TC5 denote the temperatures measured by the thermocouples positioned respectively in the ambient air, in the aqueous CaCl₂ solution, at the positive output terminal of the accumulator, at the negative terminal and on the tungsten spike that had done the piercing.

It can be seen from these curves that no thermal runaway was observed during the test.

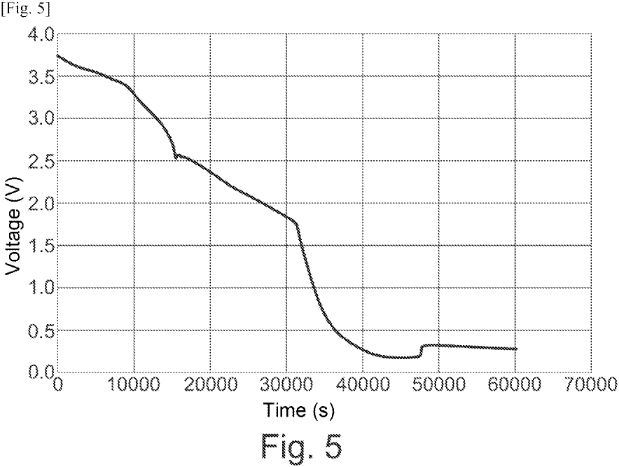

The time course of the accumulator voltage was also monitored, as illustrated in FIG. 5. It can be seen from said FIG. 5 that the accumulator had lost all of its electrical capacity in about 5 h. In other words, at the end of this time, the type 18650 accumulator has undergone complete electrical discharge.

The invention is not limited to the examples that have just been described; it is in particular possible to combine features of the illustrated examples with one another in variants that have not been illustrated.

Other variants and improvements may be envisaged, but without departing from the scope of the invention.

The example shown concerns a single accumulator: it is of course likewise possible for the same steps to be executed for a plurality of accumulators, where appropriate still assembled in modules or in a battery pack during their short-circuiting through piercing or crushing.

### List of Cited References

[1] Xuning Feng, et al. “Key Characteristics for Thermal Runaway of Li-ion Batteries” Energy Procedia, 158 (2019) 4684-4689.

1. A process for inerting at least one electrochemical accumulator (A), comprising the following steps:
0/ selecting a type of salt or mixture of salts, selecting the concentration(s) by weight thereof in an aqueous solution and selecting the cooling temperature for the aqueous solution that allows the accumulator(s) to stay at a temperature below or equal to the temperature termed the “thermal runaway temperature” T2, the selection additionally ensuring that the aqueous solution remains in a liquid state throughout cooling;
i/ supplying an aqueous solution of the salt or mixture of salts selected in step 0/;
ii/ cooling the aqueous solution of the salt or mixture of salts to the temperature determined in step 0/;
iii/ submerging the accumulator(s) in the cooled aqueous solution of the salt or mixture of salts;
iv/ short-circuiting the accumulator(s) in order to cause the electrical discharge thereof.

2. The process according to claim 1, wherein step i/ consists of supplying an aqueous solution of calcium chloride (CaCl2).

3. The process according to claim 2, wherein the CaCl2 concentration is between 0% and 30% by weight.

4. The process according to claim 1, wherein the temperature determined in step 0/ is above or equal to -50° C.

5. The process according to claim 1, wherein step iv/ is carried out by piercing or crushing the casing of the accumulator(s).

6. The process according to claim 1, wherein step iv/ is carried out for a time (t) of between 0.5 and 7 h, preferably less than 4 h.

7. The process for inerting a plurality of electrochemical accumulators according to claim 1, wherein the plurality of accumulators is assembled inside a module or inside a battery pack during steps iii/ and iv/ and where appropriate disassembled at the end of step iv/.

8. An electrochemical accumulator electrically discharged according to the process according to claim 1.

9. The electrochemical accumulator according to claim 8, consisting of a Li-ion accumulator wherein:
the material of the negative electrode(s) is selected from the group comprising graphite, lithium and the titanate oxide Li₄TiO₅O₁₂;
the material of the positive electrode(s) is selected from the group comprising LiFePO₄, LiCoO₂ and LiNi_{0.33}Mn_{0.33}Co_{0.33}O₂.

10. A process for recycling electrochemical accumulators, comprising a step of shredding of accumulators according to claim 8.

11. The process for recycling according to claim 10, wherein the shredding step is carried out subsequently to step iv/ and where appropriate in a different process system to the one executing steps i/ to iv/.
